(19) United States
(12) Patent Application Publication
(10) Pub. No.: US 2002/0186849 A1
(43) Pub. Date: Dec. 12, 2002

(54) Level meter with multi-level luminescence devices and signal console employing same

(76) Inventor: Thomas Duffy, Sunnyvale, CA (US)

Correspondence Address: KATTEN MUCHIN ZAVIS ROSENMEN, Attention: Patent Administrator, Suite 1600, 525 West Monroe Street, Chicago, IL, 60661-3693, US

(21) Appl. No.: 10/142,116

(22) Filed: May 9, 2002

Related U.S. Application Data
(60) Provisional application No. 60/290,569, filed on May 11, 2001.

(51) Int. Cl. H04R 29/00

(52) U.S. Cl. 381/58; 381/56; 381/12; 381/119; 116/202

(57) ABSTRACT

Multiple attributes of a metered signal are indicated by a level meter including a matrix-connected array of luminescence devices, suitable circuitry or software for obtaining at least three attributes of a metered signal, a control signal generator for generating a respective control signal corresponding to each of the obtained attributes of the metered signal, and a driver for driving the matrix-connected array of luminescence devices in accordance with the first, second, and third control signals. The control signals generated by the driver include a first control signal based on a first one of obtained attributes of the metered signal and adapted for operating an array of one or more consecutively arranged luminescence devices, a second control signal based on a second one of the obtained attributes of the metered signal and adapted for operating a single one of luminescence devices at a first luminous intensity, and a third control signal based on a third of the obtained attributes of the metered signal and adapted for operating a single one of the luminescence devices at a second luminous intensity visibly distinguishable from the first luminous intensity.

### CROSS-REFERENCE TO RELATED APPLICATION

Benefit is hereby claimed to the May 11, 2001 filing date of U.S. Provisional Patent Application Ser. No. 60/290,569.

### FIELD OF THE INVENTION

The present invention relates generally to level meters, such as are commonly used on sound recording consoles, and, more particularly, to a level meter that includes multi-level light-emitting diodes, preferably in a dynamic scanning figuration.

### BACKGROUND

Consoles for audio processing and other control consoles often employ level meters made up of light-emitting diodes (LED's) to display quantitative information to a user or operator of the control console. For example, a sound recording console may employ LED level meters to display the acoustic level of the composite signal output by the mixer of the sound recording console.

Previously, level meters typically employed a predetermined number of LED's and were therefore able to display the same predetermined number of numerical values or levels. Obviously, the number of levels displayed by such a level meter can be increased by simply increasing the number of LED's making up the level meter. However, the cost of LED's and associated driving circuitry, the power requirements of the LED's and associated driving circuitry, and physical space constraints on control consoles make this simple expedient undesirable. Some commercially available recording consoles employ level meters having multiple ganged or parallel-connected LED's for each level to be displayed, in order to create the appearance to lay observers that the level meter is capable of indicating more unique levels that it actually can indicate. For example, one recording console has a level meter comprising twenty-four LED's, but the LED's are illuminated in pairs so that only twelve unique “levels” can be indicated by the level meter, not twenty-four. This expedient creates the appearance that the level meter has great resolution to a non-critical observer, even though the resolution of the level meter is lower than it appears to be. While this design approach does reduce the number of control lines required for a level meter, and thus the cost of the level meter, it does not provide satisfactory resolution for most professional audio processing applications.

In addition, several techniques also have been developed for increasing the number of states that an LED can display to an operator or user (although not all such techniques are useful in conjunction with level meters). For example, instead of operating an LED in a binary fashion (i.e., either on or off), a flashing state has been added so that the LED could indicate, for example, an intermediate value between the value indicated by the LED being off and the value indicated by the LED being on. Multiple such intermediate or alternative values or states later came to be indicated by flashing the LED at multiple frequencies, each flashing frequency indicating a different value or state. However, this expedient had several shortcomings. First, with multiple flashing frequencies, it was more difficult for the user or operator to visually distinguish reliably between the various frequencies of flashing to thereby interpret what value or state was being displayed by the LED at any given time. Even for LED indicators that have only a single flashing frequency, operators frequently have misread the state indicated by the LED by glancing at the LED for a brief moment entirely within a time period during which the flashing LED was off (or entirely within a time period during which the flashing LED was on), such that the operator could not perceive that the LED was flashing to indicate the intermediate state rather than simply being off (or on). Because it is generally important that operators be able to accurately and rapidly perceive the values or states indicated by LED's on a console, this possibility for misreading of LED's is unacceptable.

In order to aid operators in reading intermediate levels, multi-colored LED's have been used to distinguish among intermediate levels. However, multi-colored LED's are expensive and require more complex and expensive driving circuitry which undesirably increases the overall cost of the control console.

### SUMMARY OF THE INVENTION

The present invention relates to the use of multi-level LED's (i.e., LED's having associated driving circuitry and/or software capable of operating the LED's at a plurality of luminous intensity or brightness levels), such as in level meters and elsewhere on audio and other consoles, in a way that overcomes the foregoing deficiencies of prior-art techniques.

According to one aspect of the present invention, a level meter for indicating multiple attributes of a metered signal includes a matrix-connected array of luminescence devices, an obtaining means for obtaining at least three attributes of a metered signal, a control signal generating means for generating a respective control signal corresponding to each of the obtained attributes of the metered signal, and a driving means for driving the matrix-connected array of luminescence devices in accordance with the first, second, and third control signals. The control signal generating means may include a first control signal based on a first one of the obtained attributes of the metered signal and adapted for operating an array of one or more consecutively arranged luminescence devices, a second control signal based on a second one of the obtained attributes of the metered signal and adapted for operating a single one of the luminescence devices at a first luminous intensity, and a third control signal based on a third one of the obtained attributes of the metered signal and adapted for operating a single one of the luminescence devices at a second luminous intensity visibly distinguishable from the first luminous intensity.

Preferably, the first control signal represents an average strength of the metered signal, the second control signal represents an instantaneous signal strength of the metered signal, and the third control signal represents a recent maximum signal strength of the metered signal.

Each luminescence device in the matrix-connected array of luminescence devices may have a respective input terminal, and the driving means may supply a respective driving current to the input terminal of each of the luminescence devices. Further, the driving currents preferably are pulse-width-modulated such that the luminescence devices collectively indicate the detected level of the metered signal.

According to a further aspect of the present invention, a signal processing console includes a signal processor; a panel having a plurality of indicators thereon including a plurality of luminescence devices for displaying an indication of a detected level of a metered signal generated by the signal processor, each luminescence device having a respective input terminal and being capable of exhibiting one of a plurality of luminous intensity levels in accordance with a signal applied to the respective input terminal; and a controller for supplying a respective control signal to the respective input terminal of each of the plurality of luminescence devices based on the detected level of the metered signal.

The indicators preferably include a matrix-connected array of luminescence devices, and the console preferably further includes an obtaining means for obtaining at least three attributes of a metered signal, a control signal generating means for generating a respective control signal corresponding to each of the obtained attributes of the metered signal, and driving means for driving the matrix-connected array of luminescence devices in accordance with the first, second, and third control signals. The control signal generating means preferably includes a first control signal based on a first one of the obtained attributes of the metered signal and adapted for operating an array of one or more consecutively arranged luminescence devices, a second control signal based on a second one of the obtained attributes of the metered signal and adapted for operating a single one of the luminescence devices at a first luminous intensity, and a third control signal based on a third one of the obtained attributes of the metered signal and adapted for operating a single one of the luminescence devices at a second luminous intensity visibly distinguishable from the first luminous intensity. Again, preferably, the first control signal represents an average strength of the metered signal, the second control signal represents an instantaneous signal strength of the metered signal, and the third control signal represents a recent maximum signal strength of the metered signal.

Each luminescence device in the matrix-connected array of luminescence devices has a respective input terminal, and the driving means preferably supplies a respective driving current to the input terminal of each of the luminescence devices, and the driving currents preferably are pulse-width-modulated such that the luminescence devices collectively indicate the detected level of the metered signal.

### BRIEF DESCRIPTION OF THE DRAWING

FIG. 1 is an illustration of a sound recording console which may employ one or more level meters in accordance with the present invention;

FIG. 2 is a schematic diagram of an array of multi-level LED's arranged in a dynamic scanning configuration for use in conjunction with the present invention;

FIG. 3 is a timing diagram illustrating operation of an array of multi-level LED's, such as that shown in FIG. 1, in accordance with the principles of the present invention;

FIG. 4 is a pictorial representation of one exemplary embodiment of a level meter in accordance with the principles of the present invention.

FIG. 5 is a schematic block diagram illustrating one exemplary embodiment of a level meter in accordance with the principles of the present invention; and

FIG. 6 is a block diagram illustrating one exemplary embodiment of software and/or hardware functionality associated with generation of signals for driving a level meter in accordance with the principles of the present invention.

### DETAILED DESCRIPTION

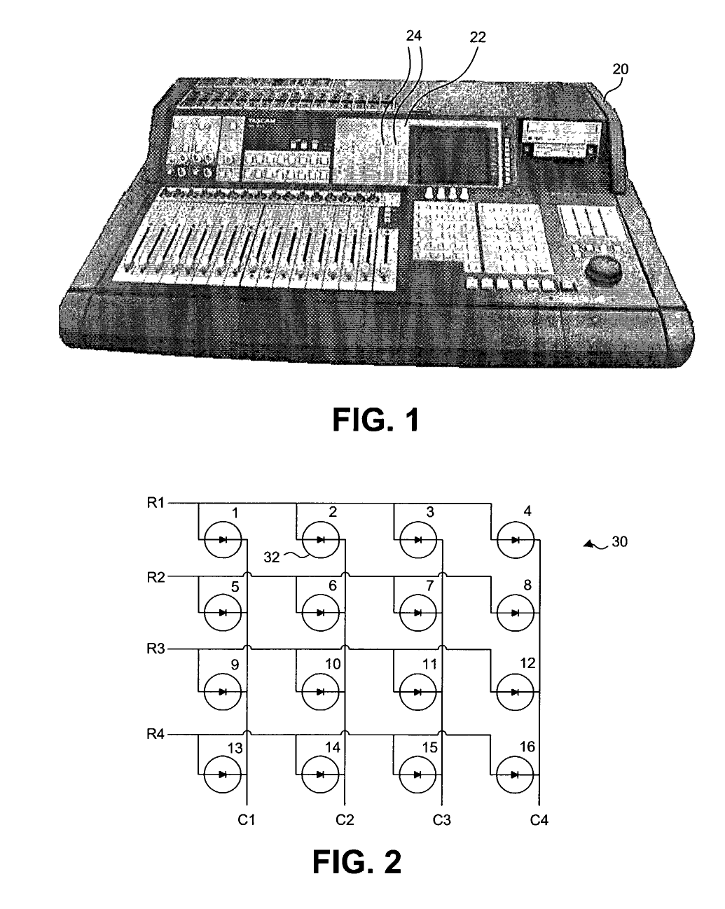

A sound recording console 20, such as the Tascam® brand sound recording console Model No. SX-1, manufactured by TEAC Corporation, is illustrated in FIG. 1. The console 20 has a front surface 22 with approximately 320 LED's 24 on the front surface 22. To economically drive all of these LED's 24, a common technique called dynamic scanning is employed by a microprocessor (not shown) that controls the LED's 24. At any one instant, only twenty-four of the LED's 24 will be driven (illuminated). Many times per second, the microprocessor changes which set of twenty-four of the LED's 24 are illuminated, creating the appearance that all of the driven LED's 24 are illuminated all the time. This phenomenon works because the human eye smoothes out high-speed visual brightness changes such as those which appear in the changing illumination output of the LED's 24.

To keep the LED's 24 scanning consistently, the microprocessor must use high-priority software routines to avoid disruption of the visual appearance of the LED's on the console 20 while the microprocessor is handling other processes. Modern electronic devices using this method may require the use of many hundreds of LED's 24. However, as described above, previous LED's were binary and hence could be set only to either “ON” or “OFF” (or could be made to flash between ON and OFF at one or more flashing frequencies).

Using a level meter according to the present invention, the console 20 can allow the normally binary LED's 24 to take on more than one level of brightness in the “ON” state. The model SX-1 recording console 20 in particular, for example, implements four brightness levels for LED's 24 that are on (e.g., approximately 25% brightness, 50% brightness, 75% brightness, and 100% brightness). 100% brightness corresponds to the brightness of a binary LED that is lit using a conventional dynamic scanning method, as will be readily understood by those of ordinary skill in the art. The actual brightness in lumens would depend on factors such as the scanning speed of the microprocessor, the characteristics of the particular LED, the driving current applied to the LED, and the current-limiting resistance employed in conjunction with the LED.

The brightness of an LED may be varied by a number of expedients, such as the well-known technique of pulse-width modulation (PWM) that is commonly employed in, for example, motor speed control and other areas. However, the relationship between the amount of time for which current is passed through an LED and the brightness of the LED is non-linear for many LED's. Empirical methods are thus generally required to calibrate the brightness levels of LED's after the LED driving circuitry has been designed. For that reason, the exemplary brightness levels listed above are only approximate.

FIG. 2 is a schematic diagram of an exemplary LED array 30 comprising sixteen light-emitting diodes or LED's 32 arranged in a dynamic scanning configuration. In other words, the sixteen LED's 32 are arranged electrically (but not necessarily physically) in four rows R1, R1, R1, and R4, with each row R1-R4 having an LED 32 in each of four columns C1, C2, C3, and C4. As will be readily appreciated by those of ordinary skill in the art, dynamic scanning is useful because it allows multiple LED's, such as the sixteen LED's 32 shown in the array 30 of FIG. 2, to be economically controlled by a microprocessor. The arrangement of the sixteen LED's 32 in a 4×4 array 30 as shown in FIG. 2 permits four of the LED's 32 to be controlled at a given time such that only eight control lines are required. In the array 30, each row R1-R4 has a respective control line, and each column C1-C4 has a respective control line. For purposes of reference herein, the row control lines in the array 30 are designated R1-R4 to correspond to the respective rows R1-R4, and the column control lines in the array 30 are designated C1-C4 to correspond to the respective columns C1-C4. In a non-dynamic scanning configuration, one control line would be required for each LED 32, such that the sixteen-LED array 30 would require sixteen individual control lines from a microprocessor instead of eight. Of course, as the number of LED's 32 in the array 30 increases, the savings in terms of the number of control lines required for a microprocessor to control the array 30 becomes substantial.

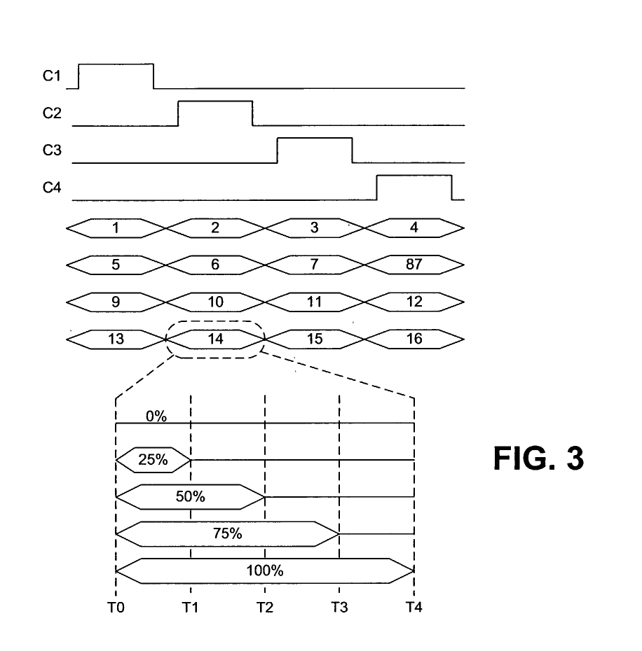

FIG. 3 is a timing diagram illustrating operation of the array 30 of LED's 32 shown in FIG. 2. As shown, the four column lines C1-C4 are made active in sequence, and the four row lines R1-R4 are made active in sequence for each successively activated column line C1-C4, in order to activate the corresponding four LED's 32 in the activated column. Thus, in the embodiment shown in FIG. 2, when the column C1 is made active, for example, the LED's 32 numbered 1, 5, 9, and 13 in FIG. 2 are made active as the respective row lines R1-R4 are made active. Thereafter, column line C1 is made inactive, and column line C2 is made active so that successive activation of the four row-lines R1-R4 operates LED's 2, 6, 10, and 14, respectively, turning those LED's ON or OFF in accordance with whatever signal is to be indicated by those LED's. This process (for a complete cycle of activating C1, C2, C3, and then C4) is repeated as many times per second as is necessary to keep all LED's 32 on the console 20 refreshed. For example, the cycle may need to be repeated more than fifty times per second to ensure that all of the LED's 32 that are illuminated on the console 20 appear to in fact be ON at the same time. In the case of the model SX-1 console 20 mentioned above, 320 LED's 32 are arranged electrically in a matrix of 16 rows and 24 columns (with some positions remaining unused). That console thus has sixteen column lines, and more than eighty cycles are performed every second. Thus, the time spent by the microprocessor for processing for a single column line is

$$\frac{1 second}{( 80 \frac{cycles}{second} ) \times ( 16 \frac{column lines}{cycle} )}$$

or approximately 780 microseconds. Turning on a row line for the full period that an individual column line is active produces an effective 100% or maximum brightness level for the LED driven by the lines at that row and column. As is well-known by those of ordinary skill in the art, there are practical constraints on the time required for the driving circuits to change any of the column lines from ON to OFF. For that reason, a period of time must be allowed between successive column line activations, during which period of time none of the row lines is made active (or, conversely, between successive row line activations, during which period of time none of the column lines is made active). This is illustrated by the downtime that appears between each adjacent pair of column line pulses C1-C4 in the timing diagram of FIG. 3. Importantly, only one of the column lines is made active at any one time, as illustrated by the pulses corresponding to activation of column lines C1-C4 being temporally mutually exclusive as illustrated in FIG. 3.

In accordance with the present invention, the LED's 32 may be multi-level LED's capable of exhibiting multiple levels of brightness when they are ON so that each such multi-level LED 32 can either simultaneously convey either multiple pieces of information or, alternatively, serve to represent a plurality of signal “levels,” each represented signal level corresponding to one of the levels of brightness that each multi-level LED can exhibit.

The selection of a particular level of brightness to be exhibited by any one of the LED's may be implemented, for example, by pulse-width modulation of the driving current that drives that LED. In other words, a particular LED may be made to exhibit a greater level of brightness by applying a drive current to that LED for a longer time and a lesser level of brightness by applying a drive current for a shorter time. For purposes of illustration, in the timing diagram of FIG. 3, the LED numbered 14 is shown to have four brightness levels in addition to an OFF state. In the illustrated embodiment, these brightness levels are 25%, 50%, 75%, and 100% brightness but more or fewer brightness levels could be used instead. The 0% brightness level corresponds to the LED being OFF. Because the LED numbered 14 in FIG. 2 is in column C2 and row R4, it is illuminated, if at all, only when column line C2 is active and the row line R4 is energized (in accordance with the timing diagram of FIG. 3). Rather than simply turning the LED numbered 14 ON or OFF, however, the following pulse-width modulation scheme is used.

At time T0 of the period during which column line C2 is active, the microprocessor begins driving the row lines coupled to LED's in column C2 (which includes the LED numbered 14 in the illustrated embodiment) that are to be more than 0% bright. At time T1, the microprocessor turns off the row lines for those LED's in column C2 that are only to be 25% bright. At time T2, the microprocessor turns off the row lines for those LED's in column C2 that are to be 50% bright, and at time T3, the microprocessor turns off the row lines for those LED's in column C2 that are to be 75% bright. Finally, at time T4, the microprocessor turns off all the row lines to allow the circuitry to settle. Thereafter, the column line C2 is made inactive, and the next column line (e.g., column line C3) is made active, and this pulse-width modulation cycle repeats from time T0 through time T4 for the LED's in that column.

A greater number of discrete brightness levels can be provided by simply further subdividing the time duration for which each column line is active and thereby increasing the number of pulse-widths of driving current that may be applied to the LED's. In general, however, the relationship between the lengths of the time-intervals between the various times T0-T4 and the corresponding brightness levels exhibited by an LED driven by a driving current during those time-intervals will be non-linear such that increasing the number of brightness levels actually requires much more precision in timing by the microprocessor. If any other processing task disrupts this timing, or makes it less accurate by delays (which is common in modern microprocessor-based operating systems), then the brightness of the LED's may vary over time, or even flicker or exhibit other inconsistencies. To at least partially alleviate this problem, the model SX-1 console 20 has a microprocessor with a built in timing generator, which is used to request priority processing at the times T0, T1, T2, T3, and T4.

In other embodiments in accordance with the principles of the present invention, a console 20 can employ LED's that blink smoothly ON to OFF and vice-versa or repeating, rather than exhibiting an abrupt ON/OFF pattern. Also, blink patterns can have two states that (e.g., fully ON and dimly ON). This allows a user of the console 10 to glance at the two-state LED briefly and be able to discern that the LED and hence the control it represents is not OFF. Prior consoles with single-level LED's forced users to observe LED's for a relatively long time in order to distinguish an LED that is OFF from one that is merely in the OFF phase of its blink cycle.

A console 10 also may use LED's with multiple brightness levels to display the strength or size of an incoming signal on a single LED. Previously, consoles implemented such signal-indicating LED's with independent driving circuitry, which required additional hardware and thus additional cost, or, in some cases, only displayed signal strength above a predetermined threshold level (i.e., the LED turned ON when the signal strength exceeded the predetermined threshold level). In accordance with the present invention, a five-level LED is used with no additional circuit complexity or expense to provide accurate and useful visual feedback of signal strength.

The present invention also may be used for implementing level meters of a sound recording console having LED's with multiple brightness levels. For example, the LED's 24 of the console 20 shown in FIG. 1 are arranged in twin columns of thirty LED's 24. Previously, these columns of thirty LED's would be able to indicate thirty different levels of an audio signal. At any given moment, a bar of illuminated LED's extending from the bottom of the column would indicate the level of the signal by the height of the bar. Varying the brightness of the uppermost LED of the column gives rise to a phenomenon known as anti-aliasing, and also makes possible the display of the signal level at four times the resolution that was possible using prior binary LED level meters (i.e., 120 different signal levels rather than 30). The signal level may be changing very frequently, but the additional resolution gives the display a smoother appearance in as perceived by the user.

In addition, multiple pieces of information can be displayed on the level meters of the console 20 using multi-level LED's 24. For example, the model SX-1 console 20 displays the following information via the above-described level meters which are made up of thirty LED's 24:

(a) average signal strength, which is displayed via a continuous bar or column of illuminated LED's (with the uppermost one being operated with multiple brightness levels as described above), and which thus has a resolution of 120 steps;

(b) instantaneous signal strength, which is displayed via a single LED illuminated at 100% brightness, and which thus has a resolution of 30 steps; and

(c) recent highest signal strength, which is displayed via a single LED illuminated at medium brightness, so that it can be distinguished from the instantaneous signal strength, and which thus also has a resolution of 30 steps. This point is continually changed to indicate the highest signal strength attained by the signal within in the immediately preceding N seconds, where N may be an integer representing a programmable length of time.

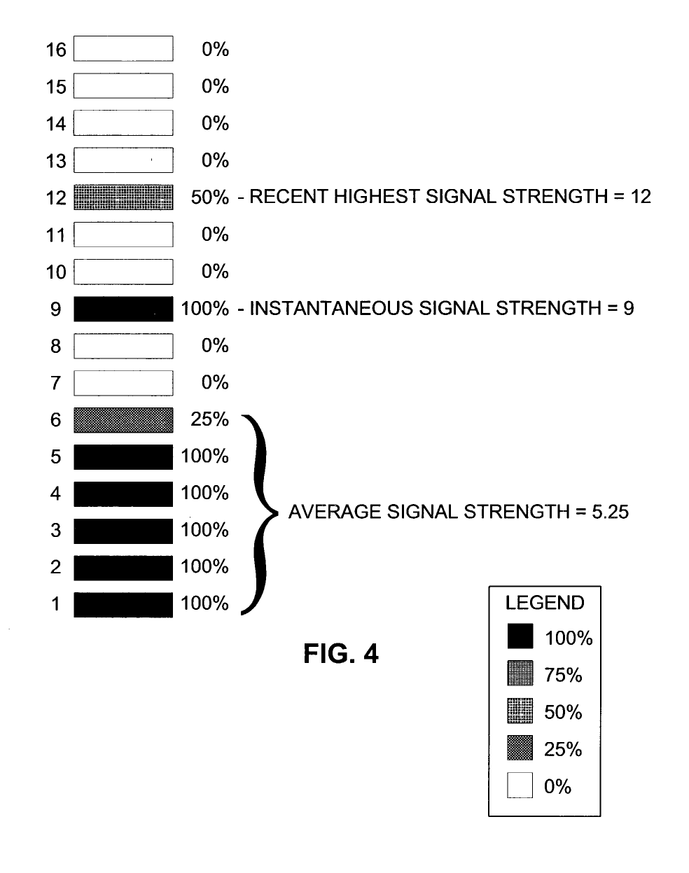

One exemplary embodiment of a level meter using multi-level LED's in accordance with the principles of the present invention is illustrated pictorially in FIG. 4. As shown, an array of sixteen LED's numbered 1 through 16 may be used to indicate three values at a time, each value representing a particular attribute of a metered signal that is to be indicated or displayed by the level meter. By way example, in the illustrated embodiment, these attributes include the average signal strength of the metered signal, the instantaneous signal strength of the metered signal, and the recent highest signal strength of the metered signal.

The first attribute, the average signal strength of the metered signal, is represented in the illustrated embodiment by an array of one or more consecutively arranged LED's or other luminescence devices in the manner generally employed by conventional VU meters. More particularly, the average signal strength of the metered signal is displayed by illuminating one or more of the luminescence devices, which preferably are continuously arranged, for example, in a column, such that the “height” of the column of illuminated luminescence devices corresponds to the average signal strength of the metered signal.

As shown, the uppermost one of the illuminated luminescence devices (numbered 6 in FIG. 4) may be illuminated to any of the available brightness levels, to thereby indicate an integer unit (i.e., 100%) or, if necessary, a fractional unit (e.g., 25%, 50%, or 75%) of signal strength of the metered signal, while all of the remaining illuminated luminescence devices below the uppermost one (e.g., the luminescence devices numbered 1 through 5 in FIG. 4) are illuminated to the maximum brightness level (100% brightness), to thereby indicate integer units of signal strength. Thus, the column of illuminated LED's shown in FIG. 4 has a height of 5.25, indicating that the metered signal has, at that time, a corresponding average signal strength value of 5.25 (i.e., the lowermost five luminescence devices are illuminated at 100% brightness, and the uppermost illuminated luminescence device is illuminated at 25% brightness). Of course, the height of the “bar” of illuminated luminescence devices will vary with the magnitude of the metered signal, and, because of the characteristic persistence of the luminescence devices, the bar of luminescence devices operated to display average signal strength in this manner generally resembles the operation of a conventional analog VU meter. As will be readily apparent to those of ordinary skill in the art, other suitable illumination scheme for exhibiting the average signal strength of the metered signal could be used instead in accordance with the principles of the present invention.

The second attribute, the instantaneous signal strength of the metered signal, is represented in real-time in the illustrated embodiment by a single illuminated LED or other luminescence device (i.e., a “dot”). More particularly, the column of LED's shown in FIG. 4 may correspond to a scale, such that the instantaneous signal strength or peak level may be displayed by illuminating a particular one of the LED's at a 100% brightness level in a relative position along the column of LED's that corresponds to the position on the scale of the value or magnitude of the instantaneous signal strength of the metered signal in the manner of conventional digital LED meters. In the illustrated embodiment, the luminescence device numbered 9 in FIG. 4 is illuminated at a 100% brightness level to represent the then-current instantaneous signal strength.

The single LED or “dot” that is illuminated to display an instantaneous signal strength appears to exhibit faster luminescence movement than the column of LED's that are illuminated to display average signal strength as described above. As a result, the movement of the single LED exhibiting instantaneous signal strength resembles the movement of a “digital peak level meter.”

The third attribute, the recent highest signal strength of the metered signal, is represented in the illustrated embodiment by a single illuminated LED or other luminescence device (i.e., a “dot”). More particularly, as shown in FIG. 4, the LED numbered 12 is illuminated at a 50% brightness level exhibit the recent highest signal strength of the metered signal. This “recent highest signal strength” value continues to be exhibited for a predetermined time interval (e.g., 1 second). Of course, the recent highest signal strength value will be continuously updated to reflect further recent highest signal strength values. In other words, if, while the recent highest signal strength is being exhibited for the predetermined time interval, the metered signal attains an even higher signal strength, that new “recent highest signal strength” value will be exhibited by illuminating a higher-numbered LED at 50% brightness, again maintaining the illumination of that LED for a predetermined time interval. In this manner, the illuminated “recent highest signal strength” LED appears to be “pushed” upward by the column of illuminated LED's indicating the average signal strength of the metered signal.

FIG. 4 illustrates an instantaneous signal strength value (represented in FIG. 4 by the illumination of the LED numbered 9 at 100% brightness) which is greater than the average signal strength (shown to be 5.25 in FIG. 4). However, it will be readily apparent to those of ordinary skill in the art that the instantaneous signal strength value also could be smaller than the average signal strength value. However, in such a circumstance, the LED that would be illuminated at 100% brightness to indicate the instantaneous signal strength would thereby be visibly indistinguishable from the column of LED's illuminated at 100% brightness to indicate the average signal strength. Accordingly, when the instantaneous signal strength is smaller than the average signal strength, the instantaneous signal strength may be exhibited by suitably darkening the appropriate LED to a lower brightness level (e.g., 25% or 0%). This will ensure that a user of the level meter will always be able to easily determine the instantaneous signal strength of the metered signal by viewing the level meter.

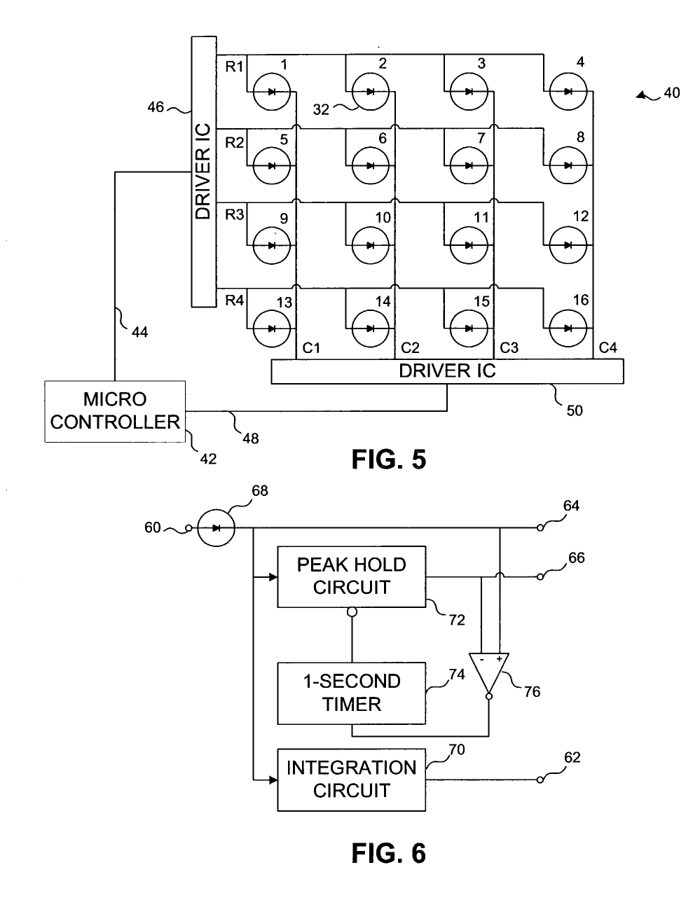

FIG. 5 depicts a block diagram illustrating one exemplary embodiment of a level meter 40 using multi-level LED's 1-16. As shown, a microcontroller 42 is connected via control line 44 to an LED driver IC 46, which provides row line driving current signals to row lines R1, R2, R3, and R4, and via control line 48 to an LED driver IC 50, which provides column line control signals to column lines C1, C2, C3, and C4. Thus, row lines R1, R2, R3, and R4 provide control signals to control the luminous intensity or brightness level exhibited by the luminescence devices (e.g., LED's), while column lines C1, C2, C3, and C4 are used to switch those control signals to particular ones of the luminescence devices.

FIG. 6 is a block diagram illustrating one exemplary embodiment of a microcontroller or microcontroller program for developing signals for controlling luminescence devices to exhibit three attributes of a metered signal in accordance with the principles of the present invention. More particularly, the microcontroller program illustrated by the block diagram of FIG. 6 accepts an analog-to-digital-converted metered signal as input at an input terminal 60 and develops an indication of average signal strength of the metered signal at an output 62, an indication of instantaneous magnitude of the metered signal at an output 64, and an indication of a recent maximum signal level at an output 66. This program may be embodied in an electric circuit or other hardware, or in software or firmware as will be readily appreciated by those of ordinary skill in the art.

As shown in FIG. 6, a conventional diode or other suitable detector 68 detects the metered signal at the input terminal 60, and the instantaneous magnitude of the metered signal is communicated directly to the output terminal 64. An integration circuit 70 is provided to integrate the instantaneous magnitude of the metered signal to develop an indication of average signal strength of the metered signal, which is then communicated to the output terminal 62. A “peak-hold” circuit 72 retains a recent highest value or peak value of the metered signal and provides that peak value to the output terminal 66. A timer 74 is coupled to a “reset” input to the peak-hold circuit 72 to reset the “peak” value held by the peak-hold circuit 72 at the end of a predetermined time interval (e.g., 1 second in the illustrated embodiment) to acquire an updated recent maximum or peak value of the metered signal. The timer 74, in turn, has a “reset” input which receives a signal from a comparator 76 which compares the instantaneous magnitude of the metered signal with the recent maximum value held by the peak-hold circuit 72 and resets the timer 74 whenever the instantaneous magnitude of the metered signal exceeds the recent maximum value held by the peak-hold circuit 72.

The program then assigns values to a plurality of variables LED1 through LED16 corresponding to control signals for controlling luminescence devices or LED's 1 through 16 (shown in FIG. 5) to indicate the average signal strength, the instantaneous signal strength, and the recent maximum signal strength for the metered signal in the manner described above.

By way of example, in controlling the luminescence devices as shown in FIG. 4, the values of these variables are:

| Variable | Value |
|---|---|
| LED1 | 100% |
| LED2 | 100% |
| LED3 | 100% |
| LED4 | 100% |
| LED5 | 100% |
| LED6 | 25% |
| LED7 | 0% |
| LED8 | 0% |
| LED9 | 100% |
| LED10 | 0% |
| LED11 | 0% |
| LED12 | 50% |
| LED13 | 0% |
| LED14 | 0% |
| LED15 | 0% |
| LED16 | 0% |

The program then scans LED variables in turn and generates control signals for controlling the luminescence devices to thereby implement dynamic scanning as illustrated in FIG. 3.

As will be readily apparent to those of ordinary skill in the art, the principles of the present invention can be implemented using any suitable indicator in addition to, or instead of, light-emitting diodes (e.g., lights, LCD and other displays, and other indicators capable of exhibiting multiple levels of brightness or any other perceivable property at one location. However, because the dynamic scanning technique does require that each matrix position act as a diode or switch, if an indicator other than a light-emitting diode is used, an additional diode, transistor, or other suitable switch would be needed to implement dynamic scanning. Further, the present invention may be embodied in control consoles of many types and is not limited to sound recording consoles or to level meters.

The foregoing description is for the purpose of teaching those skilled in the art the best mode of carrying out the invention and is intended to be illustrative only. Numerous modifications and alternative embodiments of the invention will be apparent to those skilled in the art in view of this description, and the disclosed embodiments may be varied substantially without departing from the spirit of the invention. Accordingly, the exclusive use of all modifications within the scope of the appended claims is reserved.

What is claimed is:

1. A level meter for indicating multiple attributes of a metered signal, comprising:
(a) a matrix-connected array of luminescence devices;
(b) obtaining means for obtaining at least three attributes of a metered signal;
(c) control signal generating means for generating a respective control signal corresponding to each of the obtained attributes of the metered signal, including
a first control signal based on a first one of the obtained attributes of the metered signal and adapted for operating an array of one or more consecutively arranged luminescence devices,
a second control signal based on a second one of the obtained attributes of the metered signal and adapted for operating a single one of the luminescence devices at a first luminous intensity, and
a third control signal based on a third one of the obtained attributes of the metered signal and adapted for operating a single one of the luminescence devices at a second luminous intensity visibly distinguishable from the first luminous intensity; and
(d) driving means for driving the matrix-connected array of luminescence devices in accordance with the first, second, and third control signals.

2. The level meter of claim 1, wherein the first control signal represents an average strength of the metered signal.

3. The level meter of claim 1, wherein the second control signal represents an instantaneous signal strength of the metered signal.

4. The level meter of claim 1, wherein the third control signal represents a recent maximum signal strength of the metered signal.

5. The level meter of claim 1, wherein each luminescence device in the matrix-connected array of luminescence devices has a respective input terminal, and wherein the driving means supplies a respective driving current to the input terminal of each of the luminescence devices, wherein the driving currents are pulse-width-modulated such that the luminescence devices collectively indicate the detected level of the metered signal.

6. A signal processing console, comprising:
(a) a signal processor;
(b) a panel having a plurality of indicators thereon including a plurality of luminescence devices for displaying an indication of a detected level of a metered signal generated by the signal processor, each luminescence device having a respective input terminal and being capable of exhibiting one of a plurality of luminous intensity levels in accordance with a signal applied to the respective input terminal; and
(c) a controller for supplying a respective control signal to the respective input terminal of each of the plurality of luminescence devices based on the detected level of the metered signal.

7. The console of claim 6, further comprising:
(a) a matrix-connected array of luminescence devices.
(b) obtaining means for obtaining at least three attributes of a metered signal;
(c) control signal generating means for generating a respective control signal corresponding to each of the obtained attributes of the metered signal, including
a first control signal based on a first one of the obtained attributes of the metered signal and adapted for operating an array of one or more consecutively arranged luminescence devices,
a second control signal based on a second one of the obtained attributes of the metered signal and adapted for operating a single one of the luminescence devices at a first luminous intensity, and
a third control signal based on a third one of the obtained attributes of the metered signal and adapted for operating a single one of the luminescence devices at a second luminous intensity visibly distinguishable from the first luminous intensity; and
(d) driving means for driving the matrix-connected array of luminescence devices in accordance with the first, second, and third control signals.

8. The console of claim 7, wherein the first control signal represents an average strength of the metered signal.

9. The console of claim 7, wherein the second control signal represents an instantaneous signal strength of the metered signal.

10. The console of claim 7, wherein the third control signal represents a recent maximum signal strength of the metered signal.

11. The level meter of claim 6, wherein each luminescence device in the matrix-connected array of luminescence devices has a respective input terminal, and wherein the driving means supplies a respective driving current to the input terminal of each of the luminescence devices, wherein the driving currents are pulse-width-modulated such that the luminescence devices collectively indicate the detected level of the metered signal.
